(19) United States
(12) Patent Application Publication
(10) Pub. No.: US 2013/0336756 A1
(43) Pub. Date: Dec. 19, 2013

(54) LIFTING APPARATUS AND METHOD

(71) Applicant: Pinnacle Companies, Inc., Sulphur Springs, TX (US)

(72) Inventor: Matthew HANNA, Brashear, TX (US)

(21) Appl. No.: 13/905,607

(22) Filed: May 30, 2013

Related U.S. Application Data
(63) Continuation of application No. 13/495,818, filed on Jun. 13, 2012, now Pat. No. 8,474,892.

(51) Int. Cl. B66C 1/66

(52) U.S. Cl. CPC B66C 1/663
USPC 414/800; 294/67.1

(57) ABSTRACT

There is provided an assembly for hoisting and transporting objects having support receptacles affixed to its outer surface and for moving a tank section into a desired close alignment in a predetermined location. The assembly includes a mounting bracket configured to mechanically engage with a lifting end of a crane and a lifting plate pivotally coupled to the mounting bracket. The lifting plate can have opposed non-parallel sides that are angled to engage the support receptacle during lifting of the tank section and during transportation of the tank section. When the crane moves the tank section to its desired location, the crane operator may pivot the assembly to facilitate aligning the object. Upon completion of alignment, the object is put down, and the lifting plates disengage from the support receptacles by sliding out of the slots of the support receptacles.

### CROSS-REFERENCE TO RELATED APPLICATIONS

This application is a Continuation of U.S. patent application Ser. No. 13/495,818 filed Jun. 13, 2012, which is incorporated herein by reference in its entirety.

### BACKGROUND OF INVENTION

1. Technical Field

The technology relates to the field of fluid storage tanks, and more particularly to the fabrication of large above-ground liquid storage tanks that can be used to contain brine, for example, in connection with oil and gas production.

2. Description of the Related Art

There has been an increasing demand for energy world-wide. As a result, many different technologies are being used to meet this demand, and many are under development. Current technologies include, for example, traditional oil and gas production, secondary and enhanced oil and gas recovery techniques, coal production, use of solar panels and wind turbines to generate electricity, production of bio-fuels, use of ocean waves to generate electricity, and the use of nuclear reactors to generate electricity. It is known that in several parts of the world there are large subterranean reservoirs of natural gas, a desirable clean burning fuel, held in relatively impermeable geological formations. The relative impermeability of these formations presents a challenge to the production of these gas reserves because the gas is “tightly held” within the formations and cannot readily flow to a production well.

The technique of hydraulic fracturing of impermeable subterranean formations is being used to produce gas from relatively impermeable formations. Hydraulic fracturing, also known as “fracking” or “hydro-fracking,” is a technology that fractures underground formations creating flow pathways for release of the trapped natural gas and production of that gas for commercial purposes.

During gas production, “brine” containing injected chemicals is produced. This brine must be disposed of in an environmentally acceptable manner. In addition, the fracking operation typically consumes large amounts of water for hydraulic fracturing of the formations. So, before fracking there is a need for short term storage of the hydro-fracking fluid, and after fracking there is a need to store the brine produced.

Brine may be stored above ground in storage tanks for a period of time. There are several different tank designs. However, they should preferably meet criteria of durability and resistance to leaks under the conditions of use, and should be relatively easy and inexpensive to transport and construct. In the case of some tank designs, for example circular tanks, that are made up of a series of interlocked curved wall sections, there are significant challenges on site in handling the heavy metal sections. Each wall section is hoisted by a crane and guided into place next to other already installed wall sections. In order to get a closer alignment between the wall sections to facilitate joining wall sections together, workers must manipulate the wall section into position. The use of manpower in proximity to heavy wall sections, and man-handling the wall sections, poses an issue of potential risk to the worker. In addition, the use of additional manpower to guide the wall sections into position of closer alignment incurs labor costs.

### SUMMARY OF PREFERRED EMBODIMENT

The following is a summary of some aspects and exemplary embodiments of the present technology, of which a more detailed explanation is provided under the Detailed Description section, here below.

An exemplary embodiment provides an assembly for hoisting sections of a tank wall into position during above ground tank construction. The tank wall sections are equipped with support receptacles that may be affixed temporarily or permanently to the curved outer surface of the tank wall section. The exemplary embodiment provides an assembly that includes a mounting bracket configured to mechanically engage with a lifting end of a crane. It also has lifting plates pivotally coupled to the mounting bracket. The lifting plates have opposed non-parallel sides that are configured to engage the support receptacles to thereby lift the tank wall section to which they are attached. The lifted tank wall section is transported for installation into the tank wall being constructed or repaired. To align the tank wall section more precisely and appropriately with an already-installed tank section to which it will be coupled, the assembly controllably pivots the lifting plates, about a pivot point, relative to the mounting bracket. This pivots the tank wall section into the desired position. Upon completion, the lifting plates disengage from the support receptacles by sliding away from the support receptacles, leaving the tank wall section in place.

Another exemplary embodiment provides a method of using an assembly for installing a tank wall section into a tank wall. The tank wall section has support receptacles attached to its outer surface. The pivoting assembly is attached to a lifting end of a crane. The exemplary method includes the steps of engaging a support receptacle with each of the lifting plates of the assembly, and lifting the tank wall section with the crane; moving the wall section to the desired location; and aligning the tank wall section by controllably pivoting the assembly by pivoting the lifting plates. Once the alignment is achieved, the lifting plates are disengaged from the support receptacles by sliding the lifting plates away from the support receptacles.

### BRIEF DESCRIPTION OF THE DRAWINGS

Various embodiments will be described in conjunction with the following drawings which are schematic, not to scale, and wherein like numerals denote like elements, and:

FIG. 1 is a schematic diagram showing a top view of a curved wall section of a storage tank under construction and indicating the alignment of the wall section relative to the installed wall section;

FIG. 2 is a schematic illustration of a side view portion of a wall of a storage tank showing the support receptacles used to the lift tank wall section into position;

FIG. 3 is a perspective view of an exemplary embodiment of a support receptacle to be lifted and placed in position by a pivoting assembly for hoisting objects to be lifted via attached support receptacles;

FIG. 4A, 4B and 4C are top views of an exemplary embodiment of the lifting assembly for hoisting support receptacles showing neutral and pivot positions;

FIG. 5A, 5B and 5C are perspective views of an exemplary embodiment of the lifting assembly for hoisting support receptacles of FIGS. 4 A, B and C; and

FIG. 6 is a rear view of the exemplary embodiment of the pivoting assembly for hoisting support receptacles of FIGS. 5A, 5B and 5C.

### DETAILED DESCRIPTION

The following detailed description is exemplary in nature facilitating an understanding of the inventions embodied in the appended patent claims. This detailed description is not intended to, and does not, limit the inventions to the described exemplary embodiments, or the application and uses of the exemplary embodiments. Furthermore, there is no intention to be bound by any express or implied theory presented in the preceding background, summary or the following detailed description.

Above ground tanks may contain thousands of gallons of liquid, such as fracking fluids and brine. These tanks generally have a metal circular outer wall with an inner liner enclosing the volume of liquid. The tank walls are subjected to radially outward directed forces from the pressure of the mass of liquid, which varies based on the height of liquid within the tank and the liquid's density. These walls are therefore strong and heavy and pose challenges when lifted into place at the tank site. Generally, the wall sections are fabricated off site and lifted by a hoist or crane onto a truck bed and transported to the tank site. At the site, they are individually lifted by a hoist or crane and guided into place with assistance of manual labor. Mechanization and automation of this process at the tank site would reduce the labor required and potentially improve safety.

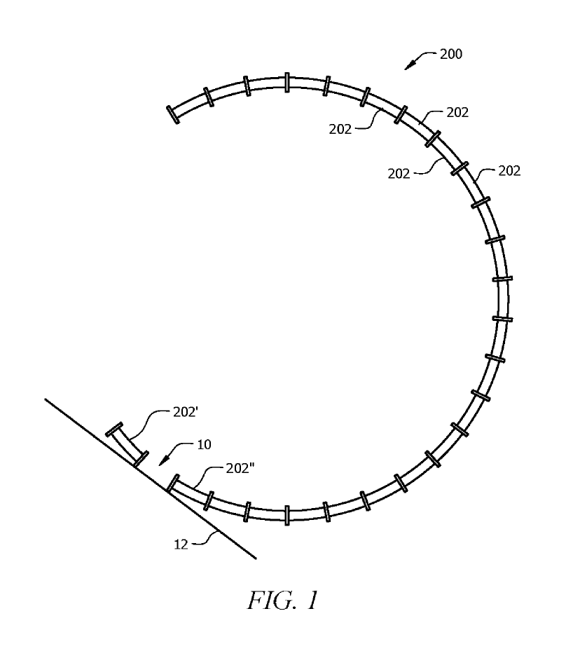

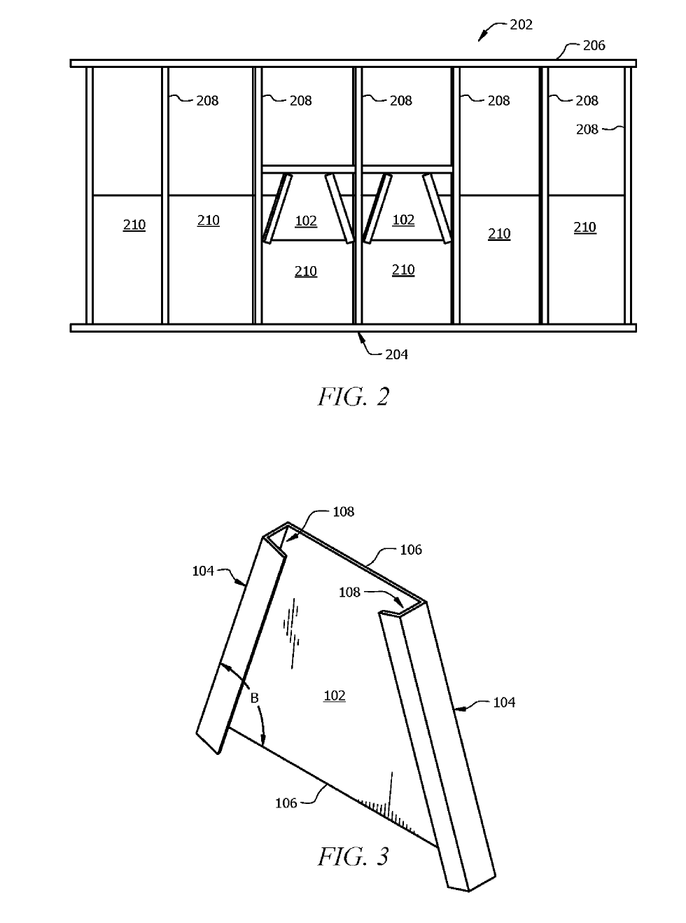

Referring to the exemplary embodiments illustrated at FIGS. 1 (a partial top view) and 2 (a partial side view), the tank wall 200 is constructed of a series of curved sections 202 that are joined together, end to end. As seen in FIG. 2, each curved section 202 of the tank wall 200, in this example, has a structure that includes a curved (circular in this exemplary case for a round tank) top beam 206 and likewise curved bottom beam 204, with vertical supports 208 at spaced intervals between the top and bottom beams. Spaces 210 between the supports 208 are metal plate, covered with thick plastic sheeting on the other side, for example, to contain the liquid inside the tank.

As seen in FIG. 2, according to an exemplary embodiment, trapezoidal support receptacles 102 are affixed on the outer surface of the tank wall section 202. These support receptacles 102 are used to lift the tank wall section for transport at the site and for placing the tank wall section in position for constructing (or repairing) the tank wall. However, while these support receptacles facilitate lifting of the tank wall sections, close alignment of the heavy tank wall section to facilitate mechanical coupling to the end of the wall section to which it much be attached, still poses challenges, and requires manual labor.

The alignment issue is illustrated in FIG. 1, where it is desired to align a new tank wall section 202″ closely with end tank wall section 202″. To achieve this closeness and alignment, the gap 10 between the tank section ends has to be closed, and in addition, the tank section ends adjacent to each other should lie on common tangent line 12 to the tank wall surface at the point of connection of sections 202′ and 202″.

Exemplary embodiments, therefore, also provide a pivot capability: the assembly is able to pivot and the crane operator is thereby able to visually align the tank wall section on the assembly before setting it down in close alignment with the tank wall end to which it is intended to be attached. Without thus pivoting capability, the hoist carrying the tank wall section would have to be repositioned, perhaps several times, before the tank wall section is aligned with the adjacent section for attachement.

Exemplary embodiments provide a lifting assembly that has a fixed relation to the crane to which it is attached, but that can swivel under operator control to more precisely align the tank wall section with the adjacent already-installed the wall section, for ease of construction. This reduces or eliminates the need for manual labor manipulation of heavy tank wall sections, with all potential attendant risks, to facilitate installation.

An exemplary embodiment of a support receptacle is illustrated in FIG. 3. In this example, the support receptacle 102 is trapezoidal, having parallel upper and lower sides 106 and non-parallel or converging sides 104. The ends of non-parallel sides 104 are folded to provide slots 108 that are sized to engage lifting plates of an assembly 100 for hoisting the support receptacles and any object to which they are attached, as explained in more detail below. Of course, support receptacles are not limited to trapezoidal shapes, but can include triangular shapes, and indeed, any shape that will allow the lifting plate of the assembly (1) to slidingly and securely engage slots of the support receptacle and prevent the support receptacle from falling off under gravity, and (2) to disengage by sliding out of the slots, when the tank wall section is set down in place aligned with the adjacent installed section of the tank wall.

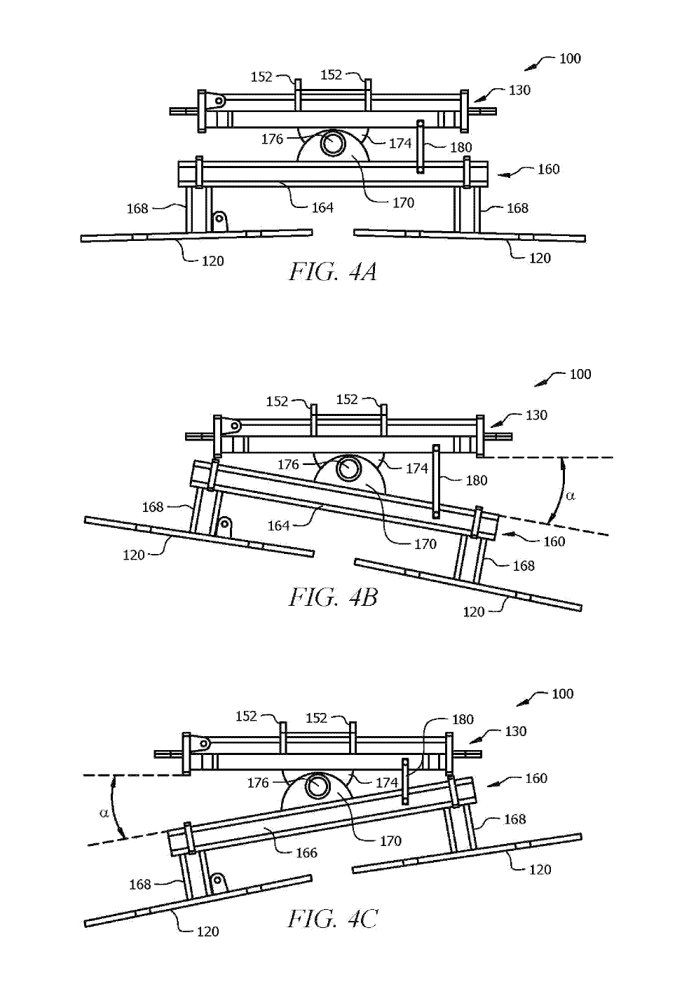

Referring to FIGS. 4-6, an exemplary embodiment of an assembly for hoisting support receptacles is illustrated in top, perspective and rear perspective views, and in three different pivot positions: neutral, pivoting to the left and pivoting to the right.

The exemplary assembly 100 shown has a pair of lifting plates 120 that are each shaped to receive a support receptacle 102. In this instance, the lifting plates 120 are trapezoidal, but may be any shape that has non-parallel converging sides that will engage the slots 108 of the support receptacles and thereby allow lifting of the support receptacles 102. In the case of the non-limiting trapezoidal example illustrated, the angle β between the lower of the two parallel sides and the non-parallel side may be less than 90° or in the range from about 60° to about 85°. Since the lifting plates and the support plates in this exemplary embodiment have matched geometry, the angle β, is best seen in FIG. 3.

The assembly 100 has a mounting bracket structure 130 for engaging a hoist to lift the support receptacles. As seen in FIG. 6, the illustrated example of a mounting bracket structure 130 has a substantially rectangular shaped upper frame 140. Upper frame 140 includes a surrounding frame 142 and an array of vertical supports 144, and is supported on lower frame structure 150. A pair of hooks 152, configured to engage with structure on the crane (not shown), extends rearward (i.e. away from the lifting plates 120) from the lower frame structure. Of course, structure, other than hooks 152 may be used, depending upon the hoist structure that must be engaged for lifting the assembly 100. The illustrated hooks 152 readily engage a coupling beam at the end of a Skycrane-type of quick connect that has a horizontal bar that fits within the hooks, and may then be secured to the hooks 152. The hydraulic controls of the crane can be used to raise, tilt and lower the assembly. Of course, other kinds of crane-coupling attachments may also be used, and the pivoting assembly is not limited to the exemplary hooks illustrated as crane-coupling devices.

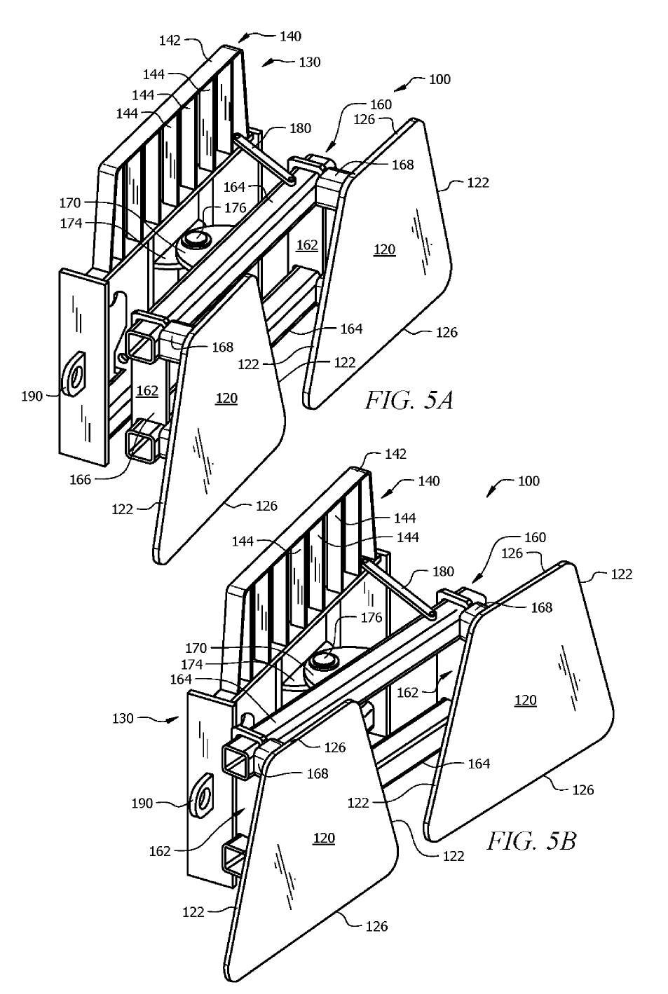

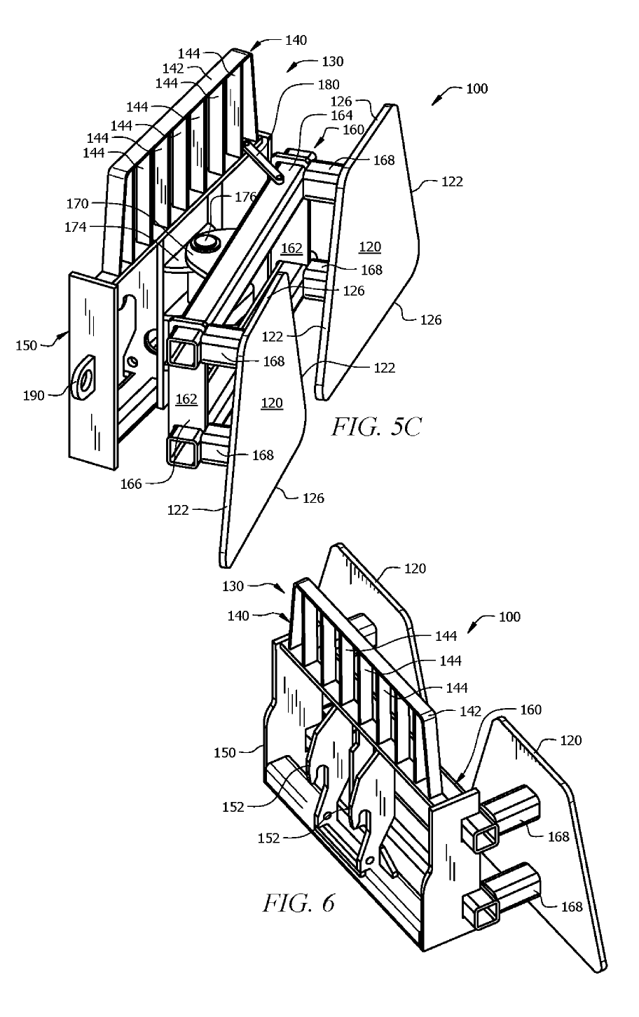

Referring to the examples of FIGS. 4 and 5, lifting plates 120 are each mounted to a plate support structure 160 that has a rectangular frame 162, shown in this example as fabricated of tubular metal. The frame 162 has a pair of horizontally extending support beams 164, joined by a pair of vertically extending support beams 166. The lifting plates 120 are supported forward of the frame 162 and are attached to the frame 162 by couplers 168. Each of the couplers 168 may be welded to the frame 162 at one end and to the rear of its respective lifting plate 120 at the other end. Of course, support structure other than a rectangular frame may be used as well.

The lifting plate support structure 160 and the mounting bracket structure 130 are mechanically coupled together to pivot with respect to each other. In the example illustrated, a first bracket 170 extends rearward from the upper frame horizontal support beam 164, and a second bracket 170 (not shown in the views) extends rearward from the lower horizontal support beam. The brackets 170 have through holes that register, and that are sized and shaped to receive a pivot pin 176. Third bracket 174 and fourth bracket (not visible in views), similar to the first and second brackets 170, extend forward from the mounting bracket structure 130 to align with the first and second brackets such that through holes in the third bracket 174 and fourth brackets align with those of the first and second brackets 170. Thus, a pivot pin may extend through all four holes since these register with each other. The lifting plate support structure 160 can therefore pivot relative to the mounting bracket structure 130 about the pivot pin 176, which is the pivot point.

To facilitate the controlled pivoting of the lifting plate support structure 160 relative to the mounting bracket structure 130, a control device (not shown) may be used to control an extendable and retractable pivot arm, such as for example, a hydraulic or pneumatic cylinder or a servomechanism 180 that can extend and retract, thereby pivoting the lifting plate support structure 160 relative to the mounting bracket structure 130 at the pivot point, where the pivot pin is located. As shown in FIGS. 4B and 4C, the angular range of pivoting is through an angle a. The angle a is not critical, but in an exemplary embodiment is sufficiently large to facilitate placement of the tank wall section on the assembly in close alignment with an adjacent tank wall section.

A pair of lifting lugs 190 shown in FIGS. 5A-C may be used to hoist the assembly 100 for transportation, or handling, or to couple it to the cooperating mechanical structure of a crane or hoist for use in lifting support receptacles.

In general, the wall sections are fabricated off-site in a machine-shop environment, and are very heavy. They are hoisted with cranes and stacked onto vehicles, like flat bed trucks, to be hauled to the site where the tank is to be constructed. On site the tank sections are readily lifted from the flat bed by using the tank wall section hoisting assembly, of which embodiments are described above. The assembly is attached to the end of a crane and may be tilted such that the plates are in an orientation suitable to slide into the support receptacles of the tank wall section. Typically, the plates would lie flat on the flat bed, so the plates would be tilted to a substantially horizontal orientation. Once the lifting plates are in the support plate slots, the assembly is raised and the plates are tilted to substantially vertical orientation, thereby lifting and tilting the tank wall section to the vertical. The tank wall section is then safely transported to any desired location, such as to on-site storage or to be added to the tank wall under construction.

At the tank wall construction site, each wall section is hoisted by a crane and guided into place next to other already installed wall sections. In order to join wall sections together it is necessary to get alignment between the wall sections and overlap of the wall edges. The tank wall section is manipulated at the end of a crane, for example, a Skycrane, so that when the tank wall section is in position, the operator pivots the assembly to bring the tank wall section into closer alignment with the end of the tank wall to which it should be coupled. Once satisfied that the tank wall section is sufficiently closely aligned for ready coupling to the tank wall, the operator sets the tank wall section down, and uses the crane end to move the assembly downward, thereby sliding the lifting plates out of the slots of the support receptacles. The operator can then repeat the process for the next tank wall section to be moved and aligned.

While at least one exemplary embodiment has been presented in the foregoing detailed description section, it should be appreciated that many variations exist. It should also be appreciated that the exemplary embodiments are only examples, and are not intended to limit the scope, applicability, or configuration of the claimed inventions in any way. Rather, the foregoing detailed description provides a convenient road map for those of ordinary skill in the art to implement exemplary embodiments. It should be understood that various changes can be made in the function and arrangement of elements described herein without departing from the scope of the patent claims listed below, including the legal equivalents of these patent claims.

1. An assembly for hoisting a tank section having a support receptacle attached to an outer surface of the tank section, the assembly comprising:
a mounting bracket configured to mechanically engage with a movable lifting device; and
a first lifting plate for engaging with the support receptacle, the first lifting plate pivotally coupled to the mounting bracket such that when the first lifting plate is bearing the weight of the tank section oriented in an upright position, the first lifting plate can be pivoted about a substantially vertical axis to change a position of an end of the tank section without moving the mounting bracket.

2. The assembly of claim 1, further comprising an adjustable pivot arm for pivoting the lifting plate relative to the mounting bracket.

3. The assembly of claim 1 further comprising:
a support structure coupled to the mounting bracket with a pivot pin;
a second lifting plate for engaging a second support receptacle;
wherein the first lifting plate is attached to the support structure at a position located on a first side of the pivot pin, and wherein the second lifting plate is attached to the support structure at a position located on a second side of the pivot pin.

4. The assembly of claim 3, further comprising an adjustable pivot arm for pivoting the support structure relative to the mounting bracket.

5. The assembly of claim 4, wherein the adjustable pivot arm comprises a hydraulic cylinder having a first end connected to the support structure and a second end connected to the mounting bracket at a location spaced from the pivot pin.

6. The assembly of claim 4, wherein the first lifting plate comprises opposed non-parallel sides configured to mate with the support receptacle and wherein the second lifting plate comprises opposed non-parallel sides configured to mate with the second support receptacle.

7. The assembly of claim 6 wherein the first lifting plate and the second lifting plate are substantially co-planar.

8. The assembly of claim 7, wherein the first lifting plate and the second lifting plate have an identical shape.

9. The assembly of claim 2, wherein the pivot arm is selected from the group consisting of a hydraulic cylinder, a pneumatic cylinder and a servomechanism.

10. The assembly of claim 9, further comprising a controller that controls the pivot arm to controllably pivot the lifting plate relative to the mounting bracket.

11. The assembly of claim 10, wherein the movable lifting device comprises a crane and the mounting bracket is configured for quick connection to a crane.

12. An assembly for hoisting a tank section having a support receptacle attached to an outer surface of the tank section, the assembly comprising:
a mounting bracket configured to mechanically engage with a lifting end of a crane;
a structural frame pivotally coupled to the mounting bracket at a pivot point, the structural frame having a plate-supporting beam extending to opposite sides of the pivot point; and
a lifting plate having opposed non-parallel sides, the opposed non-parallel sides of the lifting plate configured to mate with the support receptacle to lift the support receptacle and the attached tank section, the lifting plate mechanically coupled to the plate-supporting beam.

13. The assembly of claim 12, further comprising a pivot arm for controllably pivoting the structural frame about the pivot point relative to the mounting bracket such that an end of the tank section can be re-positioned to a different location above the ground without moving the mounting bracket.

14. The assembly of claim 13, further comprising a second lifting plate that is substantially coplanar with the lifting plate and wherein the lifting plate and the second lifting plate both have an identical trapezoidal shape.

15. The assembly of claim 14, wherein the opposed non-parallel sides of the lifting plates are at an angle β, to the lower parallel side, where β is between 60° and 85°.

16. The assembly of claim 13, wherein the pivot arm is selected from the group consisting of a hydraulic cylinder, a pneumatic cylinder and a servomechanism.

17. The assembly of claim 16, further comprising a controller that controls the pivot arm to controllably pivot the structural frame relative to the mounting bracket.

18. The assembly of claim 17, wherein the controller is manually controlled by input from an operator of the crane.

19. A method of using the assembly of claim 1, the method comprising:
sliding the lifting plate of the assembly into a slot of the support receptacle;
lifting the assembly, including the tank section attached to the support receptacle;
moving the tank section to a predetermined position;
aligning the tank section with a second tank section by pivoting the lifting plate of the assembly;
lowering the tank section into an aligned position; and
separating the lifting plate from the support receptacle by sliding the lifting plate out of the slot of the support receptacle.

20. The method of claim 19, wherein the method is performed by an operator who is operating the crane.
